(19) United States
(12) Patent Application Publication
(10) Pub. No.: US 2015/0205276 A1
(43) Pub. Date: Jul. 23, 2015

(54) METHOD FOR CONTROLLING A SYSTEM

(71) Applicant: KISTERS AG, Aachen (DE)

(72) Inventors: Markus Traeuble, Saterland (DE); Gerhard Doeding, Weyhe (DE)

(73) Assignee: KISTERS AG, Aachen (DE)

(21) Appl. No.: 14/421,621

(22) PCT Filed: Apr. 19, 2013
(86) PCT No.: PCT/DE2013/000211

§ 371 Date: Feb. 13, 2015

Related U.S. Application Data
(60) Provisional application No. 61/742,585, filed on Aug. 14, 2012.

(30) Foreign Application Priority Data
Aug. 14, 2012 (DE) 10 2012 016 066.6

(51) Int. Cl. G05B 15/02; G06N 7/00

(52) U.S. Cl. CPC G05B 15/02; G06N 7/005

(57) ABSTRACT

A computer-implementable method generates scenario trees for optimal control of systems on the basis of only stochastically describable influencing values. The scenario tree generated describes a recursive decision process, with flexible decision time points, which stably approximates the underlying stochastic processes. A large number of scenarios are generated recursively from the temporally successive branching points of the scenario structure up to the next decision time point and reduced on the basis of a suitable distance dimension. For the theoretically provable achievement of the distribution, a Fortet-Mourier metric and if appropriate a filtration distance should be taken into account for clustering the partial scenarios. The (multidimensional) values at the end of the resulting reduced scenarios result in new branching points. The decision time points can accordingly be determined according to the business-relevant requirements of the system or according to the distribution of the stochastic values underlying the decisions.

The invention relates to a method for controlling a system, in which the future behaviour of observable values forms the basis for the control function and in which scenarios are created in the tree structure and representatives are formed during the scenario reduction. Furthermore, the invention relates to computer program products with program code means for carrying out the method.

In particular, the method relates to the creation of scenarios for multi-stage stochastic optimisation problems. The method is suitable for the simulation of problems with arbitrage opportunities.

The technical problem upon which this invention is based lies in the fact that it takes a very long time, even when using very fast computers, if one is working with complex systems.

As in the case of (deterministic) optimisation, an attempt is made in the case of stochastic optimisation problems, to optimise a target function with the aid of controls or decisions. Here, various parts of the model can be subject to stochastic influences.

These stochastic parameters, which occur in the target function or the equations or inequations describing the restrictions, can be represented by a (multi-dimensional) stochastic process. A stochastic process of this type has a finite, discrete (time) horizon, it being possible to assume that the start value of the process is known.

In multi-stage stochastic optimisation problems, it is additionally required that the decisions of a stage only depend on the hitherto available information (the decision process is therefore recursive), that is to say on the realisations of the stochastic process up to this (time) stage. This is achieved by means of additional secondary conditions, the non-anticipativity restrictions.

Numerical methods must generally be used in order to solve two- or multi-stage stochastic optimisation problems. To this end, the (continuous) stochastic process must be replaced by a process with a finite number of scenarios, that is to say, the multivariate possibility distribution of the stochastic process must be replaced by a discrete distribution.

According to the modeling of the multivariate stochastic process, there have hitherto been three methods for the discretisation thereof.

Cluster generation: Generation of a finite number of scenarios by calculating independent realisations of the process. A scenario cluster results for the same start value in all scenarios using this method.

Tree reduction: Generation of a scenario cluster according to the above-mentioned method for cluster generation and combination of scenarios that behave similarly up to a (time) step. By variation of the step parameter, one obtains scenario trees using this method.

t tree generation: Starting from the start value, t scenarios are generated up to the next (time) stage. The end points thereof form the start points for generating respectively further t scenarios up to the next (time) stage. Iteratively, one obtains a t tree using this method.

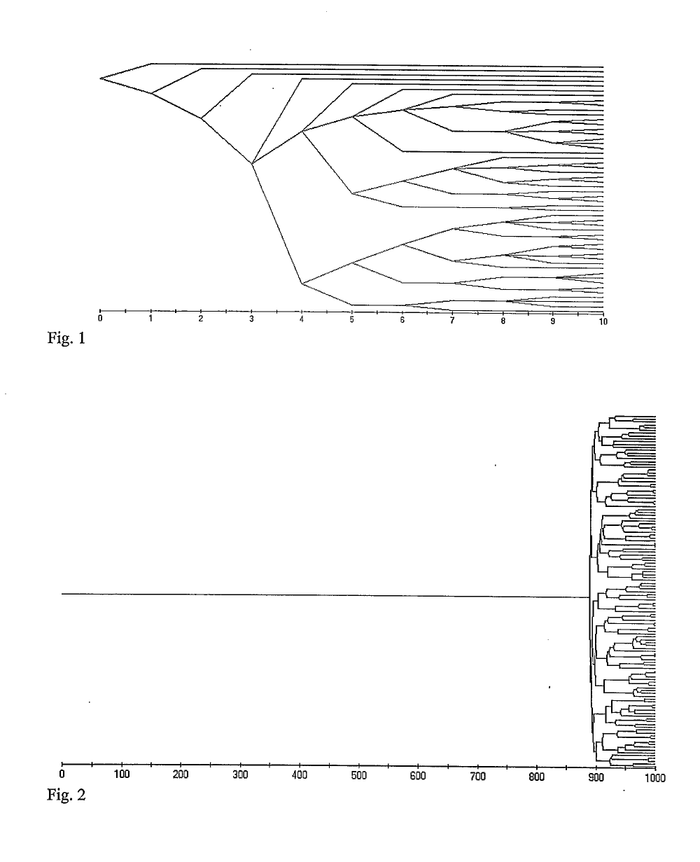

In stochastic processes with high volatility or in particular if individual processes contain a jump process, the continuous stochastic process must be replaced with a high number of discrete scenarios, in order to be represented well (FIG. 1). As the corresponding optimisation problem also enlarges with the number of scenarios, the number of scenarios is limited by memory and computing performance in the numerical solution of the problem.

Particularly when using jump processes, the continuous problem can often no longer be adequately represented and solved by scenario clusters using current computers and solution programs. A further problem of this method is the fact that in the optimisation, each scenario can only achieve an optimum individually after the start, so that an overestimating or an underestimating solution is calculated.

Larger scenario clusters can be supplied to the numerical solution by means of a subsequent tree reduction. In addition to the dependence on the remaining number of scenarios, a great dependence of the solution on the selection of representatives of similar scenarios is seen in the case of high volatility of the processes and the presence of jump processes. The selection of an existing scenario, for example the median, leads to an incorrect estimation of the target result during the solution of the optimisation problem owing to the scenario-immanent arbitrage opportunities.

Therefore, in the invention, to represent a plurality of scenarios, a distribution-dependent averaging is undertaken over the scenarios to be represented.

A further problem with the subsequent tree reduction from a scenario cluster is the discovery (clustering) of similar scenarios within the time ranges considered. Particularly in the case of processes, which model a reversion to the mean (mean reversion), the stationary distribution in convergence resulting therefrom leads in the extreme case to the resulting tree branching at an arbitrary point in time from a deterministic scenario to the full cluster (FIG. 2).

When generating a t tree, the number of scenarios increases exponentially with the number of (time) steps. Therefore, only optimisation problems with few (time) steps can be solved using this method.

The invention is based on the object, for optimisation problems with an arbitrary number of finite (time) steps, of generating a scenario structure, which describes a recursive decision process and in the process approximates the continuous process in an as accurate and (locally) stable manner as possible. By contrast with the t tree generation with an arbitrary number of finite (time) steps, a scenario structure is generated, which unlike the scenario cluster, describes a recursive decision process.

This object is achieved with a method of the generic type, in which more than 1 000 scenario structures are iteratively generated and reduced between nodes, in order to locally approximate the multivariate possibility distribution of the stochastic process asymptotically. In practice, very many (10 000 and more) scenario structures are generated in the process.

The method combines the property of t tree generation to model a recursive decision process, in which a plurality of continuations of the scenario are possible in each scenario and in each time (step), with the stability property of tree reduction to stably approximate the possibility distribution predetermined by the cluster to be reduced.

The method according to the invention is divided into a plurality of method steps:
a) Determination of the decision steps or decision (time) points.
b) Determination of the number of branching nodes at each decision (time)-point.
c) Determination of the number of scenarios, to which the scenarios generated in each node of the previous decision (time) point are reduced, on the basis of the number of decision nodes to the next decision (time) point determined in b.
d) Iterative generation of scenario clusters between decision (time) points, either the start value of the underlying stochastic process (first iteration step) or the respective end values of the scenarios generated and reduced in the preceding iteration step being used as start value of the scenario generation.
e) Reduction of the scenario cluster generated in c to the number of scenarios determined in d (tree reduction).

Step a): In the suggested method, the determination of the decision steps takes place by means of direct stipulation. Alternatively, decision steps can take place by means of a preliminary investigation of the behaviour of the underlying stochastic process using Monte Carlo methods. To this end, a sufficiently large scenario cluster is generated and subjected to a tree reduction with predetermined step size. It is suggested to be advantageous for this preliminary investigation to only take structural subprocesses into account and not to take error terms such as any jump processes that are present into account.

Step b): The determination of the number of branching nodes is based on a specification of the number of nodes for the last decision (time) point and the standard deviation of the underlying essential stochastic process at the decision (time) points. Here, the essential stochastic process is the subprocess, which is responsible for the increase in the uncertainty when increasing the decision steps (for the most part a diffusion term). The number of nodes for the last decision (time) point can again take place by means of direct specification or by means of a tree reduction carried out in advance. If the standard deviation of the underlying process at the decision (time) points is known or can be calculated, the number of nodes is determined at an arbitrary decision (time) point from the number of nodes for the end (time) point proportionally to the respective standard deviation at the relevant decision (time) point for the standard deviation for the end (time) point. Alternatively, the number of branching nodes can also be determined with a tree reduction carried out in advance with the same decision (time) points.

Note for step b): For processes with time-dependent volatility, a temporary fall in the standard deviation of the stochastic process can occur. Here, it is to be noted that in the case of decision (time) points with smaller standard deviation than in the previous decision (time) point, the number of nodes of the previous decision (time) point must be adopted, in order to ensure a number of nodes that grows evenly with the decision (time) points. In processes of this type, the decision (time) point with the highest standard deviation assumes the role of the end (time) point.

Processes, which do not include an increase of the uncertainty per se, are generally unsuitable models for stochastic optimisation and should be correspondingly amended. So, in mean-reversion processes, the mean value, which is time-dependent if appropriate, but deterministic, can be replaced with a stochastic mean value, for example by addition of a Wiener process to the deterministic mean value.

Step c): The number of scenarios, to which the scenarios generated in each node are reduced, is determined from the number of nodes of the next decision (time) point. This number is calculated proportionally with respect to the possibility of the scenario, the end value of which was the start value of the scenario cluster generated in this node.

Steps d and e): Starting with the predetermined start value, a very high number of scenarios is generated as a cluster. The next decision (time) point (Variant 1) or the end time point (Variant 2) can be used as end (time) point. This scenario cluster is reduced with a tree reduction with the two (time) steps start and first decision (time) point to the number of nodes determined for the first decision (time) point. For each scenario, starting from the first decision (time) point, a very high number of scenarios are again generated using the value of the scenario at this decision (time) point, wherein the next decision (time) point or the end (time) point is chosen as end (time) point, depending on the variant chosen in the first step. Each of these scenario clusters is reduced to the number of scenarios determined in c after the tree reduction described in the first step. This iterative generation and reduction is repeated until the end (time) point.

A computer program with computer-program coding means for carrying out the described method makes it possible to execute the method as a program on a computer.

A computer program of this type can also be stored on a computer-readable data memory.

The prior art, the method according to the invention and a comparison of the results are illustrated in the drawing and are described in the following. In the figures

FIG. 1 shows a scenario tree after tree reduction between equidistant decision points,

FIG. 2 shows a scenario tree in the case of a tree reduction from 1000 realisations of a mean reversion process to 125 scenarios,

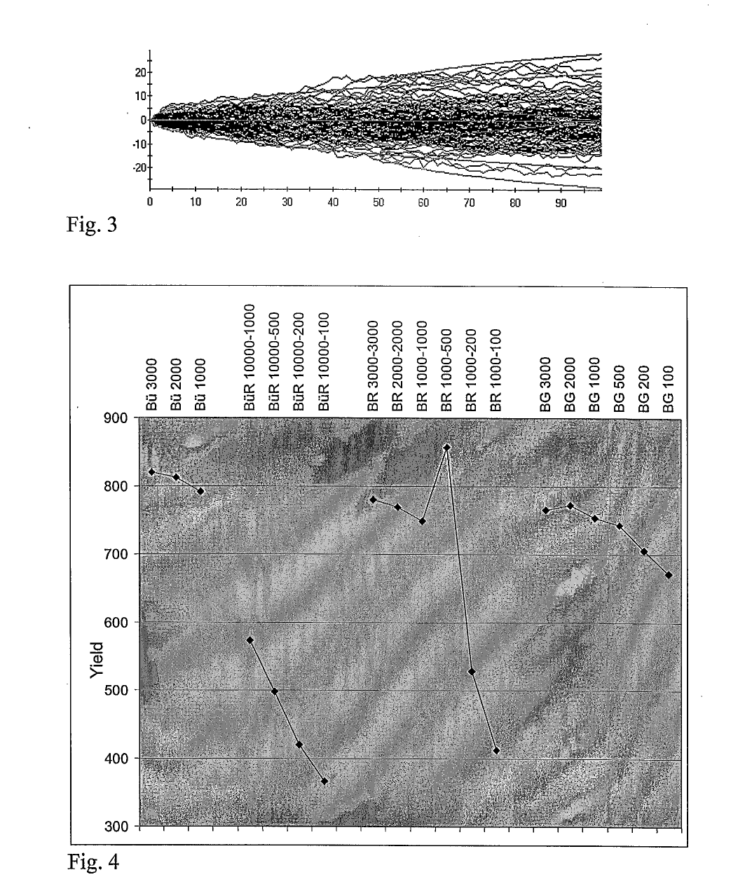

FIG. 3 shows an illustration of 100 scenarios generated by means of the described method from a Wiener process and

FIG. 4 shows a comparison of the results of the stochastic optimisation of the described optimisation problem using various scenario structures.

The scenario tree shown in FIG. 1 describes a tree reduction between equidistant decision points tᵢ=100 i where i=0 . . . 10 (x axis) to 52 scenarios. The upper leaves of the tree belong to jump scenarios, which are decoupled from the tree structure starting from the jump time point.

FIG. 2 describes a scenario tree in the case of a tree reduction from 1000 realisations of a mean reversion process to 125 scenarios.

FIG. 3 shows a scenario tree generated with the suggested method, with an underlying Wiener process and three decision points.

In this case, 100 scenarios generated by means of the described method from a Wiener process with decision time points t₀=0, t₁=50 and t₂=100 are illustrated. ±2 t^{0.5} environments for selected nodes starting from the decision time points t₀ and t₁ are highlighted.

The results of a stochastic optimisation of the following optimisation problem are compared in FIG. 4.

A vessel, which is initially filled with water with a certain temperature, can receive water from the market per time step (day steps) up to a quantity or is output to the market up to a certain quantity. The water temperature of the received and output water quantities follows a stochastic process, which is described by a mean reversion jump diffusion model. The object is to determine the expected temperature in the vessel after five weeks.

Various scenario structures were called upon to this end. Cluster generation with 3000, 2000 and 1000 scenarios (Bü 3000, Bü 2000 and Bü 1000). Cluster reductions (that is to say a tree reduction with the decision time points start time point and end time point) from 10000 scenarios to 1000, 500, 200 and 100 scenarios (BüR 10000-1000, Bü 10000-500, Bü 10000-200 and Bü 10000-100) and also the suggested tree generation with 3000, 2000, 1000, 500, 200 and 100 scenarios.

The cluster generations in each case achieve the highest temperature, which can be interpreted as overestimation owing to the arbitrage opportunities within the scenarios. In the cluster reduction, due to the combination and weighting of the scenarios, the more extreme scenarios increasing the temperature have less influence on the result than the scenarios close to the mean value. Even in the case of the chosen short time horizon and the moderate volatility of the stochastic process, this leads to a considerable instability of the results with regards to the number of remaining scenarios. The tree reduction is sufficiently stable in the front region, but no longer in the case of genuine scenario reduction.

Of all investigated reduction methods, the suggested method shows the best stability characteristics with regards to the results of the stochastic optimisation.

The described method is also suitable for other tasks. For example, the method helps with the control of systems, in which the future behaviour of observable values forms the basis for the control function.

This for example makes it possible to input historical weather data, such as solar intensity, wind speed and amount of precipitation, as original input, whilst the power consumption at certain times of day is applied as output value. By means of a corresponding optimisation, the response is optimised in such a manner that the output becomes ever more stable and thus the output error becomes ever smaller. Thereafter, the network can be used for prognoses, in that prognosticated weather data can be input and power consumption values to be expected are determined.

Whilst for calculations of this type using a conventional process in practical use, many time-consuming investigations were necessary for finding the optimal scenarios, the method according to the invention allows a result within a few seconds or minutes.

The described method therefore allows a great reduction of the required time, for example in the case of a predetermined artificial neuronal network. Furthermore, the required network can also be made smaller without the quality of the results suffering as a result.

1. A computer-implementable method for controlling a system, in which the only statistically describable future behavior of observable values forms the basis for the control function and scenario structures with an arbitrary number of finite (time) steps for describing a recursive decision process are generated, wherein more than 1000 scenario structures are iteratively generated and reduced between nodes (branching points of the scenario structure at the decision time points), in order to locally approximate the multivariate possibility distribution of the stochastic process asymptotically.

2. The method according to claim 1, wherein recursively generated and reduced partial scenarios begin with the values, with which the temporal precursors thereof end.

3. The method according to claim 1, wherein the number of partial scenarios at the decision nodes according to the stochastic process determining decisive blurring are calculated in advance.

4. The method according to claim 2, wherein the reduced partial scenarios are distribution-dependent weighted mean value scenarios.

5. The method according to claim 1, comprising the following method steps:
a) Determination of the decision steps or decision (time) points,
b) Determination of the number of branching nodes at each decision (time)-point,
c) Determination of the number of scenarios, to which the scenarios generated in each node of the previous decision (time) point are reduced, on the basis of the number of decision nodes to the next decision (time) point determined in b,
d) Iterative generation of scenario clusters between decision (time) points, wherein either the start value of the underlying stochastic process (first iteration step) or the respective end values of the scenarios generated and reduced in the preceding iteration step are used as start value of the scenario generation and
e) Reduction of the scenario cluster generated in d to the number of scenarios determined in c (tree reduction).

6. A computer program product with programming code means for carrying out a method according to claim 1 when the program is executed on a computer.

7. The computer program product with programming code means according to claim 6, wherein the same are stored on a computer-readable data memory.
